(19) United States
(12) Patent Application Publication
(10) Pub. No.: US 2008/0104646 A1
(43) Pub. Date: May 1, 2008

(54) RECEIVER, RECEPTION SYSTEM AND COMMUNICATION METHOD

(75) Inventor: Tomohiro KANDA, Saitama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/765,610

(22) Filed: Jun. 20, 2007

(30) Foreign Application Priority Data
Oct. 31, 2006 (JP) 2006-296634

(51) Int. Cl. H04N 7/173

(52) U.S. Cl. 725/110

(57) ABSTRACT

According to one embodiment, a receiver includes a communication section that links with an external device to receive moving image information corresponding to a link destination and link information; an update section that updates the link information to latest link information repetitively at a predetermined timing; a combining section that generates screen information to display the received moving image information and the latest link information on a screen; and a control section that receives an operation signal specifying a link destination included in the latest link information. The control section changes the link destination in the communication section to the link destination specified by the received operation signal when the control section receives the operation signal.

### CROSS-REFERENCE TO RELATED APPLICATIONS

This application is based upon and claims the benefit of priority from Japanese Patent Application No. 2006-296634, filed Oct. 31, 2006, the entire contents of which are incorporated herein by reference.

### BACKGROUND

1. Field

This invention relates to a receiver, a reception system, and a communication method for receiving moving image information and link information dynamically through a network from a provider.

2. Description of the Related Art

In recent years, not only use of broadcast service of one-way TV broadcast, etc., but also use of two-way video on-demand service that is distribution service of any desired content in response to user's demand has been expanded with development and diversification of digital transmission technology.

JP-A-2004-159367 discloses an example of a two-way TV program guide system for a video on-demand browsing service.

However, JP-A-2005-159367 involves the following problem: The link destination that can be selected for one displayed link is fixed to one and if a transmission is made from one screen to another in response to user's demand, the link destination assigned to limited selection means such as a button of a remote control, for example, is not adapted to change in synchronization with the display image at the time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram to show a configuration example of a receiver according to one embodiment of the invention;

FIG. 2 is a schematic representation to show an example of a link hierarchy of the receiver according to the embodiment of the invention;

FIG. 3 is a schematic representation to show an example of a display screen of the receiver according to the embodiment of the invention;

FIG. 4 is a flowchart to show an example of link control processing of the receiver according to the embodiment of the invention;

FIG. 5 is a flowchart to show an example of operation playback processing of the receiver according to the embodiment of the invention;

FIG. 6 is a flowchart to show an example of link information reception processing of the receiver according to the embodiment of the invention; and

FIG. 7 is a schematic representation to show an example of transition of display screens of the receiver according to the embodiment of the invention.

### DETAILED DESCRIPTION

Various embodiments according to the invention will be described hereinafter with reference to the accompanying drawings. In general, according to one embodiment of the invention, a receiver includes a communication section that links with an external device to receive moving image information corresponding to a link destination and link information; an update section that updates the link information to latest link information repetitively at a predetermined timing; a combining section that generates screen information to display the received moving image information and the latest link information on a screen; and a control section that receives an operation signal specifying a link destination included in the latest link information. The control section changes the link destination in the communication section to the link destination specified by the received operation signal when the control section receives the operation signal.

### <Receiver According to one Embodiment of the Invention>

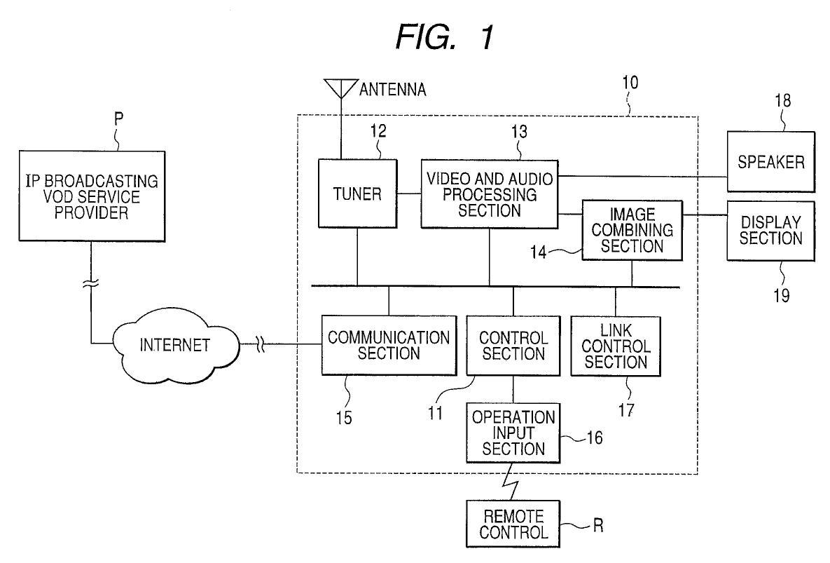

To begin with, a configuration example of a receiver according to one embodiment of the invention will be discussed with FIG. 1. FIG. 1 is a block diagram to show a configuration example of a receiver according to one embodiment of the invention.

As an example of the receiver according to the embodiment of the invention, in FIG. 1, a receiver 10 can communicate with a provider (server) P for conducting loop distribution of a sample and advertisement of moving image content by multicast. The receiver 10 includes a control section 11 for controlling the whole operation, a tuner 12 having tuner functions of receiving digital broadcasting and analog broadcasting of terrestrial broadcasting, BS broadcasting, CS broadcasting, etc., and a video and audio processing section 13 having an MPEG decode function, a decode function, etc., for processing various video and audio signals.

The receiver 10 further includes an image combining section 14 for combining various pieces of control information of link information, etc., into a usual image (in other word, the image combining section 14 generates a screen information to display various pieces of control information on one screen), a communication section 15 for communicating with the provider P, etc., through a network such as the Internet or the like, a remote control R having numeric keys, etc., an operation input section 16 having a communication function with the remote control R, etc., and further including operation buttons, etc., a link control section (update section) 17, for managing link information described later, etc., a speaker 18 for outputting audio from the video and audio processing section 13, and a display section 19 for displaying video from the video and audio processing section 13.

The receiver 10 receives and demodulates digital broadcasting and analog broadcasting of usual broadcast signals in the tuner 12 and displays content on the display section 19. The receiver 10 can also download and play back content information directly from the provider P, etc., via the Internet through the communication function 15 in response to an operation signal from the operation input section 16 arbitrarily selected by the user and display the content information on the display section 19 as a Video On Demand (VOD®) function.

### <Example of Link Processing of the Embodiment of the Invention>

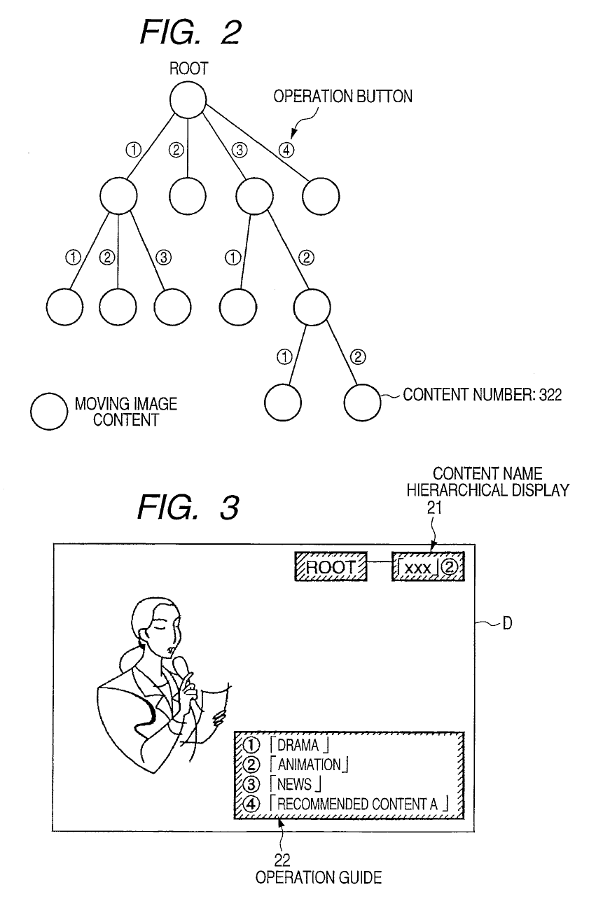

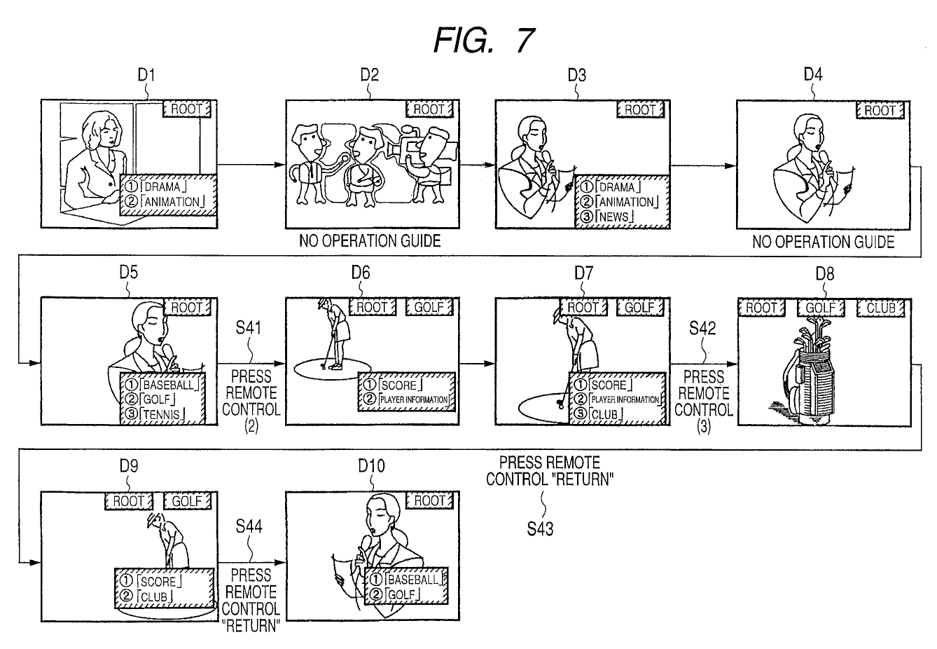

Next, an example of link processing of the embodiment of the invention will be discussed in detail with flowcharts, etc. FIG. 2 is a schematic representation to show an example of a link hierarchy of the receiver according to the embodiment of the invention. FIG. 3 is a schematic representation to show an example of a display screen of the receiver according to the embodiment of the invention. FIG. 7 is a schematic representation to show an example of transition of display screens of the receiver according to the embodiment of the invention.

### (Detailed Description of Link Processing)

In broadcast and VOD service using IP communications, the receiver 10 of the embodiment of the invention makes it possible to conduct loop distribution of a sample and advertisement of moving image content by multicast and make a transition to VOD service or loop distribution of different multicast as the user selects content to be viewed. That is, at the same time as the receiver 10 downloads and plays back moving image content from the provider P, the receiver 10 receives hierarchical link information as shown in FIG. 2 and always updates the link information and displays the link information on a screen D as the user can select any of the entries with the numeric keys, etc., of the remote control R, etc., as an operation guide 22 shown in FIG. 3. The position of the current link in the hierarchy in FIG. 2 can also be displayed as content name hierarchical display 21.

First, at the function start time of the terminal, reception processing of the initial address (ROOT) for multicast is performed and the received packet is played back. At the same time, by multicast, the URL of content of VOD and address information of different multicast are also be transmitted from a server (about one packet every sec to 0.1 sec) and are received at the terminal. The received information is utilized as follows:

During multicast (UDP, RTP) content reception, in the multicast (UDP, RTCP), URL information destined for unicast and a different address for multicast are also received at the same time. Information to make access to a different stream is called link information.

The link information is updated with time in agreement with content. If the user presses a DETERMINE button, a numeric button, etc., of the remote control R, switching to the corresponding content is performed based on the link information at the point in time.

The corresponding content includes two types of unicast and multicast.

When the Corresponding Content is Unicast: Mainly VOD

The address (URL) of an RTSP server or an HTTP server is accessed and a procedure for starting to send a stream to the server is executed.

A received packet is played back and when playing back the packet terminates, the process returns to reception of the stream before selection of VOD. Link information may be received in unicast during playing back and when the link information contains one or more entries, it is made possible to switch to a different stream.

When the Corresponding Content is Multicast: Loop Distribution

A procedure for starting to receive selected multicast is executed and a received packet is played back. When playing back the packet terminates, the process returns to reception of the previous multicast. Link information may be received by multicast during playing back and when the link information contains one or more entries, it is made possible to switch to a different stream.

The link information is updated for each reception and may contain no entry to switch to, in which case the previous information is cleared and a state in which no entry exists is entered.

When the stream is switched according to the link information, the location of the former stream before the stream is switched is saved in a stack.

Each entry is formed as operation button: URL: content name (option).

The operation guide 22 may be entered in moving image content or may be generated in the terminal based on the received link information and text may be superposed on moving image content.

To select the link destination in the operation guide 22, preferably the numeric operation buttons are used and with one digit as one operation, selected (branch) content is represented by the content number in such as manner that the selected content branches several times with several digits, namely, content can be selected by entering several digits.

That is, if the user selects “322” at a time, preferably the control section 11 and the link control section 17 interpret the same link destination as the user selects “3, ” “2,” “2” in order.

Since reaction is slow if switching is performed in order, the control section 11, the link control section 17, and the image combining section 14 are provided with the following function: The search URL recorded in the terminal is used to search for a several-digit number and the result is received as the URL or address information for multicast of the corresponding content from the server. Then, playback processing of the content is performed.

Preferably, the control section 11, the link control section 17, and the image combining section 14 display the currently selected content name in a video image like the content name hierarchical display 21 in FIG. 2. At this time, the link hierarchy can also be displayed at the same time.

Preferably, the control section 11, the link control section 17, and the image combining section 14 is provided with a non-display mode in which the operation guide 22 containing a plurality of link destinations is not displayed in screen information, and can select the non-display mode arbitrarily in response to an operation signal of the user.

Preferably, not only the IP communications, but also the tuner 12 is utilized to superpose information of reception of link information on a broadcast signal and the information is detected and a content move of IP communications is made.

That is, preferably, with a broadcast using radio waves as ROOT, link information is received by multicast while the radio wave broadcast is received, whereby a move is made to content in the link information by user operation.

It is also preferable that a move be able to be made from IP moving image content to radio wave broadcast.

Likewise, it is also preferable that a move be made from IP moving image content to a WWW page or that a move be made from a WWW page to IP moving image content. To do this, the URL of a WWW page is contained in link destination information or link information is received in unicast or multicast while a WWW page is being referenced.

### (Specific Example of Screen Display)

FIG. 7 shows an example of screen display provided by the functions. As shown in FIG. 7, the receiver 10 of the embodiment of the invention displays link destination candidates as the operation guide 22 and the position of the current link in the hierarchy as the content name hierarchical display 21 at the same time on a screen D1 where moving image content is played back. The link information is dynamic and changes with the progress of a program; it may disappear as on a screen D2, different link information may be displayed as on a screen D3, or again the link information may disappear as on a screen D4.

If the user specifies link destination (2) GOLF in the operation guide 22 on a screen D5 by operating the numeric key, etc., of the remote control R, etc., (step S41), the link destination of the communication section 15 is changed to the link destination of (2) GOLF and video of the new link destination is displayed as on a screen D6.

Further, the time elapses and change is made to new link destination as on a screen D7 and at this point in time, if the user specifies link destination (3) CLUB by operating the numeric key, etc., of the remote control R, etc., (step S42), the link destination of the communication section 15 is changed to the link destination of (3) CLUB and video of the new link destination is displayed as on a screen D8.

At this stage, if the user presses a RETURN key, etc., of the remote control R, etc., (step S43), the screen returns to the previous link destination (2) GOLF as on a screen D9 and if the user further presses the RETURN key, etc., of the remote control R, etc., (step S44), the link destination returns to ROOT as on a screen 10.

Thus, in the receiver 10 of the embodiment of the invention, the link destination is always updated with the passage of time and the user can change the link destination in real time by simple operation of pressing any numeric key, etc., of the remote control R to view any desired content.

### (Detailed Description of Link Processing Using Flowcharts)

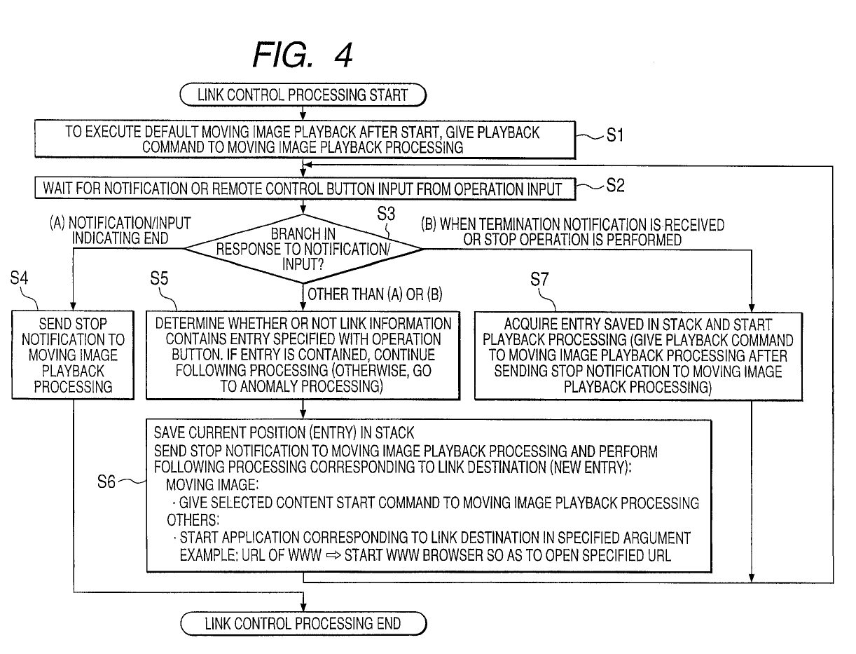

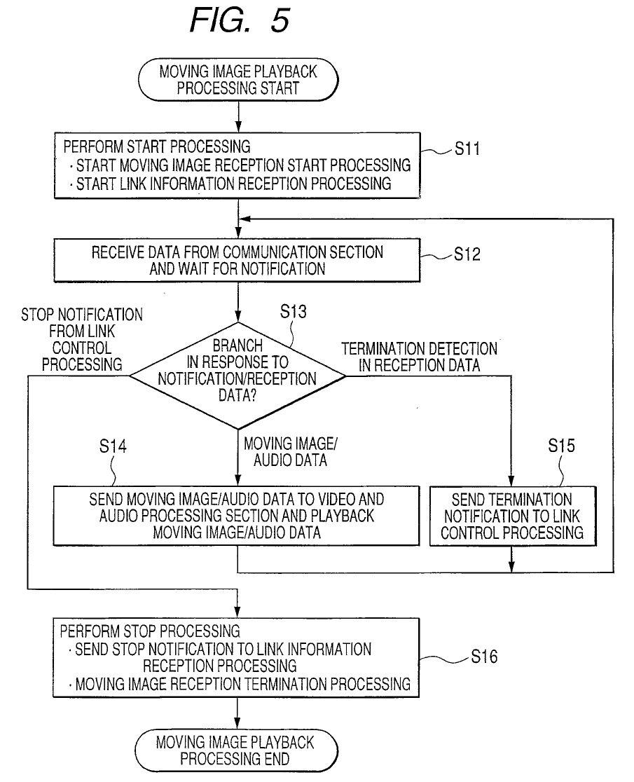

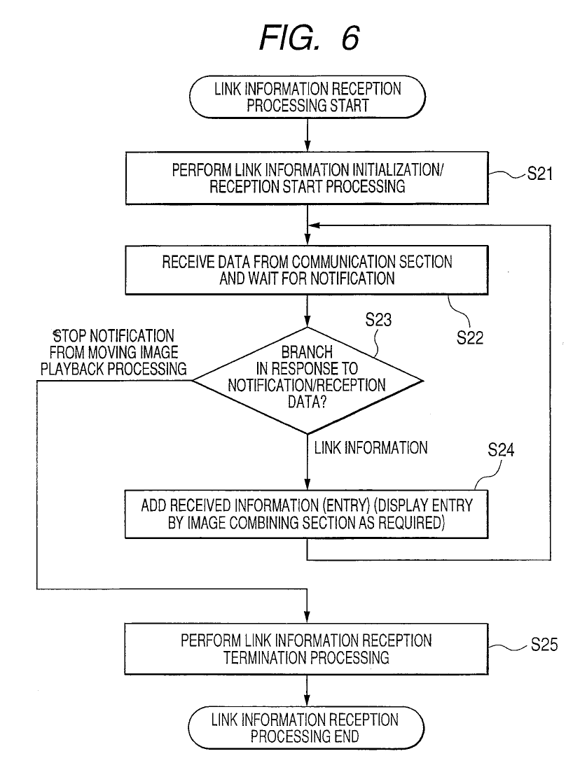

Next, three types of processing to make possible the link function of the receiver 10 of the embodiment of the invention described above, namely, link control function specified in a flowchart of FIG. 4, moving image playback processing specified in a flowchart of FIG. 5, and link information reception processing specified in a flowchart of FIG. 6 will be discussed in detail.

To begin with, the link processing of the embodiment of the invention is implemented as the operation of link control function specified in the flowchart of FIG. 4. Further, it is implemented as moving image playback processing shown in the flowchart of FIG. 5, the operation of which is controlled by the link control processing, and link information reception processing in the flowchart of FIG. 6 following the moving image playback processing.

Link Control Processing (FIG. 4)

In the receiver 10 of the embodiment of the invention, as shown in the flowchart of FIG. 4, when the user turns on power of the receiver and starts the VOD function by operating the remote control R, etc., the control section 11 and the link control section 17 start the moving image playback processing shown in the flowchart of FIG. 5 described later at the timing (step S1). Accordingly, the communication section 15 downloads any desired moving image content and link information from the provider P through a network such as the Internet and video corresponding to the moving image content is displayed on the display section 19.

The control section 11 and the link control section 17 wait for the user to operate the remote control R, etc., to give an operation signal or a command in a state in which one moving image content is played back (step S2). Here, for example, if the user turns off a power switch of the remote control R, etc., or presses a VOD function stop switch, the control section 11 and the link control section 17 send a stop notification to the moving image playback processing in FIG. 5 described later (step S4). Here, for example, if the user presses a playback stop switch or the return key of the remote control R, etc., or a termination notification is received from the provider P, etc., the control section 11 and the link control section 17 acquire the link destination, etc., saved in a stack of a storage area (not shown) and start playback processing of the link destination (step S7).

If the user presses a numeric key of the remote control R, etc., to specify one link destination in the operation guide 22, the control section 11 and the link control section 17 determine whether or not the link information contains address information specified with the numeric keys, etc., and if address information is contained, continue the following processing; otherwise, perform anomaly processing (step S5). That is, the control section 11 and the link control section 17 save the current position (entry) in the stack of the storage area. The communication section 15 accesses new link destination and plays back the corresponding moving image. If a URL, etc., rather than moving image content is specified, the communication section 15 accesses the URL, downloads information in the specified URL, and decodes the information for display on a screen (step S6).

Next, the operation of the moving image playback processing started in the link control processing and the link information reception processing will be discussed in detail.

Moving Image Playback Processing (FIG. 5)

The moving image playback processing is started at step S1 of the link control processing in FIG. 4 or the like. The control section 11 and the link control section 17 initialize link information and start the communication section 15, etc., for accessing the link destination specified by the operation signal of the user, etc., and at the same time, start the link information reception processing in FIG. 6 described later (step S11). The communication section 15, etc., downloads any desired moving image content and link information from the provider P, etc., (step S12).

Moving image and audio data is supplied to the video and audio processing section 13 and playback processing is continued (step 314).

Then, upon reception of a stop notification from step S4 in the flowchart of the link control processing in FIG. 4 described above or the like, stop processing is performed and a stop notification is sent to the link information reception processing in FIG. 6 described later and the moving image playback is also terminated (step S16).

If a termination signal is detected in reception data supplied from the provider P, etc., the control section 11 and the link control section 17 send a termination notification to the link control processing in FIG. 4 (step S15).

Link Information Reception Processing (FIG. 6)

The link information reception processing is started mainly at step S11 of the moving image playback processing in FIG. 5 or the like. The control section 11 and the link control section 17 initialize link information and start the communication section 15, etc., for accessing the link destination specified by the operation signal of the user, etc. The communication section 15, etc., downloads link information as well as any desired moving image content from the provider P, etc., (step S22).

Upon detection of received link information (step S23), the control section 11 and the link control section 17 update the received link information autonomously at all times if an operation signal from the remote control R by the user is not received. It is also preferable that the control section 11 and the link control section 17 update the received link information autonomously every predetermined time (for example, every second). Preferably, the control section 11 and the link control section 17 detect change in the link information autonomously at all times and update the link information if change exists (step S24). Accordingly, it is made possible to display from the screen D1 to the screen D2 with no operation guide to the screen D3 with a new operation guide.

Such link information reception processing is continued until reception of a stop notification from the moving image playback processing (step S23). Upon reception of a stop notification, the control section 11 and the link control section 17 terminate the link information reception processing (step S25).

The receiver 10 according to the embodiment of the invention described in detail enables the user to easily select content. That is, the link destination on the screen is referenced, selection is utilized, and the moving image content playback start time of the user can be matched, so that the cost of the sending server can be reduced as compared with the case where unicast is often used by making the most of loop distribution using multicast.

If an advertisement is entered in moving image content, the cost-effectiveness of the advertisement can be enhanced in such a manner that an advertisement narrowed to the taste is entered in unicast and that an advertisement narrowed to the time/term is entered by multicast. The user also references moving image content until arriving at the target content, so that the time of referencing an advertisement of the moving image is also prolonged relatively.

Further, the receiver 10 according to the embodiment of the invention also enables the user to move seamlessly from a radio wave broadcast to IP content.

As described above, according to one embodiment of the invention there is provided a receiver, a reception system, and a communication method capable of providing a plurality of link destinations dynamically when a moving image is played back.

According to one embodiment of the invention, a plurality of link destinations depending on the progress of a program are selected with numeric keys, etc., of a remote control, etc., whereby operability can be improved and while content is being selected, moving image content can also be viewed, so that it is made possible to prolong the time referencing the moving image content.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A receiver comprising:
a communication section that links with an external device to receive moving image information and link information, the moving image information corresponding to a link destination;
an update section that updates the link information to latest link information repetitively at a predetermined timing;
a combining section that generates screen information to display the received moving image information and the latest link information on a screen; and
a control section that receives an operation signal specifying a link destination included in the latest link information,
wherein the control section changes the link destination in the communication section to the link destination specified by the received operation signal when the control section receives the operation signal.

2. The receiver according to claim 1,
wherein the latest link information displayed on the screen includes a plurality of link destinations and hierarchical information of the link destinations.

3. The receiver according to claim 1,
wherein the control section receives the operation signal based on a numeric key of a remote control and specifies a link destination assigned to the numeric key, included in the latest link information.

4. The receiver according to claim 1,
wherein the combining section and the control section is capable of taking a non-display mode in which only the moving image information is displayed on the screen.

5. The receiver according to claim 1,
wherein the link destination includes a URL or address information for multicast.

6. The receiver according to claim 1,
wherein the control section includes a storage area that stores previous link destination before the link destination in the communication section is changed, and
wherein the control section returns the link destination in the communication section to the previous link destination in response to an operation signal.

7. The receiver according to claim 1, further comprising a tuner section that receives and demodulates a broadcast signal and obtains a link information from a signal provided by demodulating the broadcast signal.

8. The receiver according to claim 1,
wherein the link information is updated in agreement with content of the moving image information.

9. A reception system comprising:
a server that generates and transmits moving image information and link information; and
a receiver comprising:
a communication section that links with the server to receive moving image information and link information, the moving image information corresponding to a link destination;
an update section that updates the link information received by the communication section to latest link information, repetitively at a predetermined timing;
a combining section that generates screen information to display the received moving image information and the latest link information on a screen; and
a control section that receives an operation signal specifying a link destination included in the latest link information,
wherein the control section changes the link destination in the communication section to the link destination specified by the operation signal when the control section receives the operation signal.

10. The reception system according to claim 9,
wherein the latest link information displayed in the screen includes a plurality of link destinations and hierarchical information of the link destinations.

11. A communication method between a server and a receiver, the communication method comprising:
generating moving image information and link information at the server, the moving image information corresponding to a link destination;
transmitting the moving information and the link information to the receiver;
receiving the moving image information and the link information at the receiver;
updating the link information to latest link information repetitively at a predetermined timing;
generating screen information to display the received moving image information and the latest link information in a screen; and
receiving an operation signal specifying a link destination included in the latest link information;
changing the link destination in the server to the link destination specified by the operation signal when the operation signal is received.
